(19) United States
(12) Patent Application Publication
(10) Pub. No.: US 2022/0227671 A1
(43) Pub. Date: Jul. 21, 2022

(54) METHOD FOR PREPARATION OF POROUS MULLITE CERAMIC FROM PICKERING EMULSION

(71) Applicant: INDIAN INSTITUTE OF TECHNOLOGY MADRAS (IIT MADRAS), Chennai (IN)

(72) Inventors: Nithin M, Chennai (IN); Manas MUKHERJEE, Chennai (IN); Basavaraj M GURAPPA, Chennai (IN)

(73) Assignee: INDIAN INSTITUTE OF TECHNOLOGY MADRAS (IIT MADRAS), Chennai (IN)

(21) Appl. No.: 17/595,893

(22) PCT Filed: May 21, 2020
(86) PCT No.: PCT/IN2020/050457

§ 371 Date: Nov. 29, 2021

(30) Foreign Application Priority Data
May 30, 2019 (IN) 201941021525

(51) Int. Cl. C04B 35/185

(52) U.S. Cl. CPC C04B 35/185; C04B 2235/6562; B82Y 30/00; C04B 2235/3463; C04B 2235/5454; C04B 2235/606

(57) ABSTRACT

An improved method for preparing porous mullite ceramic from Pickering emulsions stabilised by hetero-aggregate of oppositely charged fumed oxide particles. The method uses oppositely charged fumed oxide nano-particles (silica and alumina) to stabilize oil-in-water Pickering emulsions wherein the stabilized Pickering emulsions can be used as a template for preparing porous mullite material. An optimised Pickering emulsion template that is stabilised with fumed oxide nano-particles (silica and alumina) is used to produce a green body that is transformed into solid porous material with a controlled porosity and pore size by sintering.

### TECHNICAL FIELD

Embodiments are generally related to field of material science and engineering. Embodiments are further related to porous mullite ceramics. Embodiments are also methods for preparation of porous mullite ceramics. Embodiments are particularly related to method for preparing porous mullite ceramic from Pickering emulsions stabilised by hetero-aggregate of oppositely charged fumed oxide particles.

### BACKGROUND OF THE INVENTION

Porous mullite is a potential material with a wide range of applications due to its unique material properties. A porous mullite ceramic has material properties including intrinsic low thermal conductivity, low thermal expansion coefficient, exceptional thermal shock resistance, good creep resistance and good chemical stability in harsh chemical environments. Porous mullite ceramics can be used in a wide range of applications such as high temperature insulation and filter membrane for highly corrosive and high-pressure environments.

However, the functional properties desirable for a given application is highly dependent on the composition and microstructure of the porous network, which in turn depends on the processing technique. Methods and process for processing and preparing porous mullite and mullite-based composites are well known in the art. Such conventional methods include replica-based methods, sacrificial templating and direct foaming methods. The techniques differ greatly in terms of processing conditions and final microstructures/properties achieved. Among these techniques, sacrificial templating offers the possibility to control the microstructure of the final ceramic component through the appropriate choice of the sacrificial material. However, removal of sacrificial phase may take more time with generation of large amount of gases leading to cracking of the cell wall. So, it is advisable to use liquid pore formers (water, oil, emulsions etc.) that will easily evaporate from the green body.

Particle stabilized emulsions and foams can be used as an excellent template for preparing porous ceramics through consolidation of emulsion. The interfacially adsorbed particles on the surface of the drops hinder the coalescence process during solvent extraction. The effectiveness of the particles in stabilizing emulsions depends on their size, shape, wettability and charge on the particle. The most recently explored aspect is the charge on particle surfaces. It was shown that highly charged particles alone cannot stabilize emulsions because of the electrostatic repulsion preventing their adsorption to the oil-water interface. Additives to screen the charge are needed to overcome the repulsive energy barrier and to enhance the adsorption of particles to the interface.

Formulation of emulsions employing oppositely charged particles has garnered great attention in the recent past. In using these oppositely charged particles, the key is to form aggregates of low effective net charge, which favour emulsion stabilization. In such systems, the stability and size distribution of the emulsion droplets strongly depend on the hetero-aggregate structures formed, which is a function of several parameters such as charge ratio, number ratio, concentration of particles, contact angles of the particles and aqueous phase properties such as pH and ionic strength. Due to their gel-like nature and long-term stability, Pickering emulsions are suitable precursors for preparing porous materials. The particle network provides enough green strength to the dried emulsion body.

Based on the foregoing a need therefore exists for an improved porous mullite ceramic suitable for a wide range of high temperature insulation and filter membrane for highly corrosive and high-pressure environments. Also, a need exists for an improved method for preparing porous mullite ceramic from Pickering emulsions stabilised by hetero-aggregate of oppositely charged fumed oxide particles, as discussed in greater detail herein.

### SUMMARY OF THE INVENTION

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

One aspect of the disclosed embodiments is to provide an improved porous mullite ceramic for a wide range of applications such as high temperature insulation and filter membrane for highly corrosive and high-pressure environments.

Another aspect of the disclosed embodiments is to provide an improved method for preparing porous mullite ceramics using Pickering emulsions.

Further aspect of the disclosed embodiments is to provide a method for preparing porous mullite ceramic from Pickering emulsions stabilised by hetero-aggregate of oppositely charged fumed oxide particles.

The aforementioned aspects and other objectives and advantages can now be achieved as described herein. An improved method for preparing porous mullite ceramic from Pickering emulsions stabilised by hetero-aggregate of oppositely charged fumed oxide particles, is disclosed herein. The method uses oppositely charged fumed oxide nano-particles (silica and alumina) to stabilize oil-in-water Pickering emulsions wherein the stabilized Pickering emulsions can be used as a template for preparing porous mullite material. An optimised Pickering emulsion template that is treated with fumed oxide nano-particles (silica and alumina) is used to produce a green body that is transformed into solid porous material with a controlled porosity and pore size by sintering.

The high stability of the particle stabilized Pickering emulsions aids in maintaining of their microstructure throughout the drying process. An extended control over the mouldability of emulsion is ensured by its gel-like behaviour. The liquid phase components of the emulsion can be removed by evaporation before the sintering step. Also, no additive is required to bind the dried emulsion body. The high reactivity of the fumed oxide particle due to their nano size and defective structure increases the sintering speed and permits mullite phase evolution at lower temperatures by reducing the energy consumption and processing time.

Furthermore, the ceramic precursor acts as an emulsion stabilizer and gets adsorbed around the droplet during emulsification. The proposed invention efficiently controls the pore size of the final ceramic structure by tuning the emulsion droplet size. The droplet size largely depends on the mixing fraction of the particles, aqueous phase pH and the homogenisation speed which eventually control the pore size in the final ceramic. The microstructure of the final ceramic consisting of micron sized pores with nano-porous struts adds to the effective tortuosity, porosity and surface area of the porous mullite material.

### BRIEF DESCRIPTION OF DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of the nano-tomography images of the sintered porous mullite ceramic material obtained from Pickering emulsion, in accordance with the disclosed embodiments;

FIG. 2 illustrates the X-ray diffraction (XRD) spectrum showing development of the phases as a function of the sintering temperature, in accordance with the disclosed embodiments;

FIG. 3 illustrates a graphical representation of pore sizes in the porous mullite ceramic, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An improved method for preparing porous mullite ceramic from Pickering emulsions stabilised by hetero-aggregate of oppositely charged fumed oxide particles, is disclosed herein. The method uses oppositely charged fumed oxide nano-particles (silica and alumina) to stabilize oil-in-water Pickering emulsions wherein the stabilized Pickering emulsions can be used as a template for preparing porous mullite material.

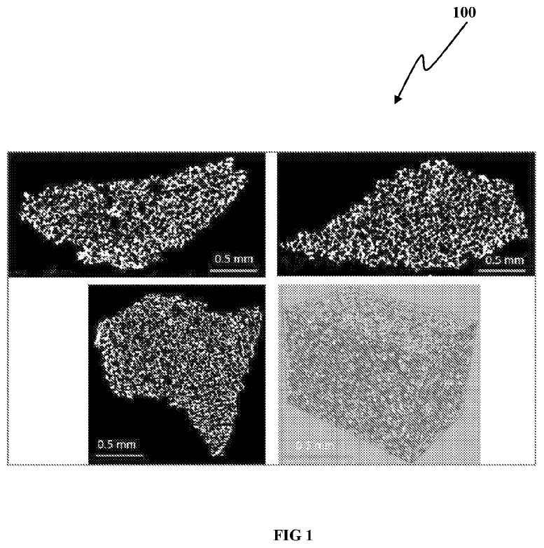

FIG. 1 illustrates a schematic view 100 of the nano-tomography images of the sintered porous mullite ceramic material obtained from Pickering emulsion, in accordance with the disclosed embodiments. An optimised Pickering emulsion template that is treated with fumed oxide nano-particles (silica and alumina) is used to produce a green body that is transformed into solid porous material with a controlled porosity and pore size by sintering.

The high stability of the particle stabilized Pickering emulsions aids in maintaining of their microstructure throughout the drying process. An extended control over the mouldability of emulsion is ensured by its gel-like behaviour. The liquid phase components of the emulsion can be removed by evaporation before the sintering step. Also, no additive is required to bind the dried emulsion body. The high reactivity of the fumed oxide particle due to their nano size and defective structure increases the sintering speed and permits mullite phase evolution at lower temperatures by reducing the energy consumption and processing time.

Furthermore, the ceramic precursor acts as an emulsion stabilizer and gets adsorbed around the droplet during emulsification. The proposed invention efficiently controls the pore size of the final ceramic structure by tuning the emulsion droplet size. The droplet size largely depends on the mixing fraction of the particles, aqueous phase pH and the homogenisation speed which eventually control the pore size in the final ceramic. The microstructure of the final ceramic consisting of micron sized pores with nano-porous struts adds to the effective tortuosity, porosity and surface area of the porous mullite material.

From FIG. 1, the black region corresponds to the pores and the white region corresponds to the ceramic matrix. The visualisation and tortuosity calculation were carried out using SIMPLEWARE commercial software package. Tortuosity was calculated by two different ways, (I) average tortuosity between two points in opposite surface randomly chosen from the 3D image, τ=1.32 (2) along the long axis diagonal τ=1.49. The obtained tortuosity values are reasonably good and confirm porous nature of the material. It also confirms that pores are interconnected and hence suits for functional applications at high temperature.

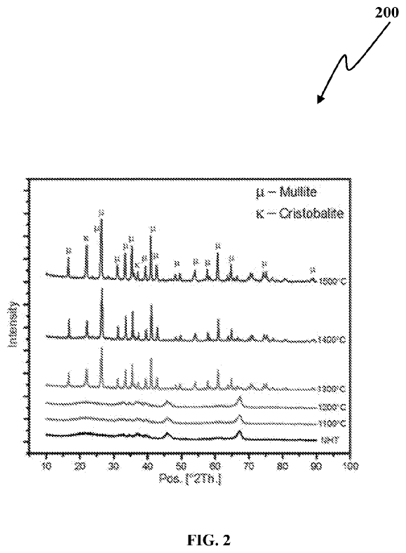

FIG. 2 illustrates the X-ray diffraction (XRD) spectrum 200 showing development of the phases as a function of the sintering temperature, in accordance with the disclosed embodiments. The porous mullite ceramic is prepared through consolidation of Pickering emulsion stabilized by fumed alumina (AeroxideAlu C) and fumed silica (Aerosil 200) hetero-aggregates. The Pickering emulsion is prepared by mechanical shearing a mixture containing decane and dispersion of oppositely charged particles (OCPs). The emulsions were prepared in a 40 mL beaker and OCPs at the optimised compositions were initially mixed in water. The total volume of the oil phase and water phase was fixed at 25 mL.

The obtained mixture was then emulsified with a homogeniser (IKA T25 ULTRA TURRAX) at 13000 rpm for 3 min. The porous ceramic was prepared by drying and sintering of emulsion gel stabilized by oppositely charged particles. Green ceramic body was obtained by casting Pickering emulsion into PVC pipe mould. Samples were placed in a humidity controlled drying chamber and dried at temperature 30° C. at a relative humidity of 70%. The green structure was then subjected to sintering in a tubular furnace at 10° C. min⁻¹ heating rate in air for 3 h at different temperatures in the range of 1100 to 1500° C.

The phases of raw materials and as sintered samples were determined through X-ray diffraction technique (XRD) (PANalytical X′pert PRO diffractometer), performed using Cu Kα radiation at 40 kV and 30 mA in the 2θ range of 10−90° with a step size 0.02°. The mullite is the only stable binary phase in the Al₂O₃—SiO₂ system existing at ambient conditions. However, from the results, it can be observed that hetero-aggregation and emulsification occurs in the intermediate mixing fraction (0.2-0.8). From alumina-silica phase diagram, stoichiometric ratio can be 3:1, in order to obtain 3:2 mullite phase. Consequently, the mixing fraction of 0.35 fumed silica (0.65 alumina) was chosen for preparing emulsion template.

5 wt % OCP stabilized emulsion under optimized condition (pH 6 & φ=0.35 of silica) is used for preparing the porous mullite. The removal of dispersed phase of emulsion and densification of particles at the interface during sintering led to the formation of porous structure. The process does not need a setting reaction to prevent droplet coalescence. The process such as shaping, drying and sintering has accomplished for fabricating porous ceramics. Drying is a critical step among these because collapse of emulsion structure driven by the capillary pressure leads to a drastic reduction in the porosity. To avoid this collapse, drying under controlled humidity is adopted. Finally, sample is strengthened by sintering process, where the solid-state diffusion leads to particle contacts, grain growth and phase evolution.

Evolution of mullite phase was characterised by XRD. The XRD patterns of the porous ceramics sintered at different temperatures (in the range 1100-1500° C.) for 3 h are shown in FIG. 2. It shows that mullite phase formation is found to occur at 1300° C. and above. The results match with those of the phase formation from the diphasic system based on reactive alumina and amorphous silica. The splitting of the peak located at ˜26° in the spectrum reveals the formation of orthorhombic mullite (3Al₂O₃·2SiO₂, orthorhombic system, PDF#01-079-1455), which indexed to (120) and (210) crystalline planes.

Apart from mullite, peaks at 21.9° and 36.2° correspond to cubic cristobalite and observed peak intensity decrease with temperature. They are for high temperature crystalline phase of silica that deteriorates the properties of mullite at elevated temperature. As compared to clay minerals-based precursors, large quantity of mullite phase evolved at low temperature that can be attributed to the reactive nanosized raw materials.

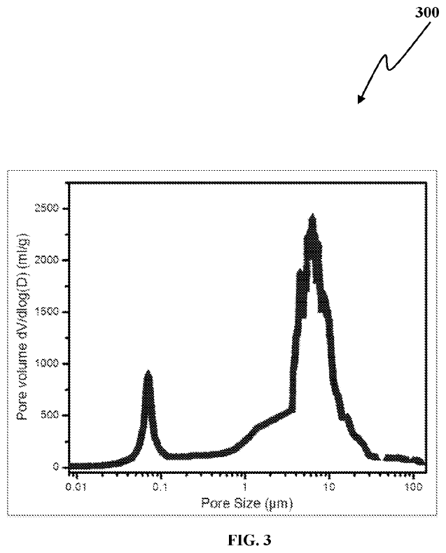

FIG. 3 illustrates a graphical representation 300 of pore sizes in the porous mullite ceramic, in accordance with the disclosed embodiments. The porosity or open porosity and bulk density values of sintered ceramic at 1500° C. (calculated using ASTM C 20) are 76% and 0.46 g/cc, respectively. The distribution of pore sizes is again measured by mercury intrusion porosimetry (MIP) that accounts for both micro porosity and nano porosity, as shown in FIG. 3. The distribution is bimodal, and peaks were observed at pore diameters of −0.07 μm and 8 μm.

The average pore sizes (especially in micro porosity range) are much smaller than that obtained from electron microscopy observations. It is considered as a limitation of MIP technique known as “bottleneck effect” where small pores and pore throat diameter are accounted instead of large pores. The average specific surface area obtained from this technique is 11.8 m²/g which is comparable to the reported values.

The pore interconnectivity is highly important in applications such as filters for molten metals and exhaust gases and scaffolds. The pore interconnectivity or interconnection length is quantitatively represented as tortuosity (τ) which is inversely proportional to porosity.

X ray nano-tomography is performed which is often used to observe the internal structure of sintered ceramic. Tortuosity was then determined by visualisation and analyses of these tomogarphs. X-ray tomography images of the porous specimens in all the three directions (front, top and side) and the 3D image are shown in FIG. 1.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the field.

I/We claim:

1. An improved method for preparing porous mullite ceramic from Pickering emulsions stabilised by hetero-aggregate of oppositely charged fumed oxide particles, said method comprising:
using oppositely charged fumed oxide nano-particles (silica and alumina) to stabilize oil-in-water Pickering emulsions wherein the stabilized Pickering emulsions can be used as a template for preparing porous mullite material.
using optimised Pickering emulsion template that is formulated with fumed oxide nano-particles (silica and alumina) to produce a green body that is transformed into solid porous material with a controlled porosity and pore size by sintering.

2. The method as claimed in claim 1 wherein the high stability of the particle stabilized Pickering emulsions aids in maintaining of their microstructure throughout the drying process wherein the extended control over the mouldability of emulsion is ensured by its gel-like behaviour.

3. The method as claimed in claim 1 wherein the liquid phase components of the emulsion can be removed by evaporation before the sintering step without any additives to bind the dried emulsion body.

4. The method as claimed in claim 1 wherein the high reactivity of the fumed oxide particles due to their nano size and defective structure increases the sintering speed and permits mullite phase evolution at lower temperatures by reducing the energy consumption and processing time.

5. The method as claimed in claim 1 wherein the ceramic precursor acts as an emulsion stabilizer and gets adsorbed around the droplet during emulsification.

6. The method as claimed in claim 1 wherein the pore size of the final ceramic structure is controlled by tuning the emulsion droplet size wherein the droplet size largely depends on the mixing fraction of the particles, aqueous phase pH and the homogenisation speed which eventually control the pore size in the final ceramic.

7. The method as claimed in claim 1 wherein the microstructure of the final ceramic consisting of micron sized pores with nano-porous struts adds to the effective tortuosity, porosity and surface area of the porous mullite material.

8. The method as claimed in claim 1 further comprising:
preparing the porous mullite ceramic through consolidation of Pickering emulsion stabilized by fumed alumina (Aeroxide Alu C) and fumed silica (Aerosil 200) hetero-aggregates;
preparing the Pickering emulsion by mechanical shearing a mixture containing decane and dispersion of oppositely charged particles and OCPs at the optimised compositions were initially mixed in water wherein the volume ratio of oil phase to aqueous phase was fixed at 1:1; and
the resulting sample consisting of oil and aqueous phases was then emulsified with a homogeniser (IKA T25 ULTRA TURRAX) at 13000 rpm for 3 min wherein the porous ceramic was prepared by drying and sintering of emulsion gel stabilized by oppositely charged particles.

9. The method as claimed in claim 8 wherein the green ceramic body was obtained by casting Pickering emulsion into PVC pipe mould wherein the samples were placed in humidity controlled drying chamber and dried at temperature 30° C. at a relative humidity of 70%.

10. The method as claimed in claim 8 wherein the green structure is subjected to sintering in a tubular furnace at 10° C. min−1 heating rate in air for 3 h at different temperatures in the range of 1100 to 1500° C.
